(19) United States
(12) Patent Application Publication
(10) Pub. No.: US 2003/0139970 A1
(43) Pub. Date: Jul. 24, 2003

(54) Electronic method for determining procurement business strategy

(76) Inventors: Teresa B. Badura, Hyde Park, NY (US); Bonnie A. Bartlett, Walden, NY (US); Cathy A. Buresch, Charlotte, NC (US); Thomas M. Carr, Alpharetta, GA (US); Luis Cruz, Plattekill, NY (US); James P. Gilbert, Pleasant Valley, NY (US); Judy J. Kogut-O'Connell, Hopewell Junction, NY (US); Carol A. O'Reilly, Woodbury, CT (US); Donna M. Platt, Poughkeepsie, NY (US); Cheryl K. Reese, Siler City, NC (US); Ann T. Storms, Poughkeepsie, NY (US); Mary M. Tamney, Poughkeepsie, NY (US); Pamela S. Tesch, Altura, MN (US); John Wilczewski, Pleasant Valley, NY (US)

Correspondence Address: FREDERICK W. GIBB, III, MCGINN & GIBB, PLLC, 2568-A RIVA ROAD, SUITE 304, ANNAPOLIS, MD, 21401, US

(21) Appl. No.: 09/943,841

(22) Filed: Aug. 31, 2001

(51) Int. Cl. G06F 17/60

(52) U.S. Cl. 705/26

(57) ABSTRACT

A method and structure for selecting from a plurality of communication arrangements is performed by inputting a first party's ability to communicate with a second party. The invention evaluates the communication arrangement based on the first party's ability to communicate and repeats the evaluating process for a different communication arrangement if the first party's ability does not match a communication arrangement previously evaluated. The invention performs a cost-benefit analysis with respect to a communication arrangement matching the first party's ability and implements a communication arrangement when the first party's ability matches a communication arrangement. The cost-benefit shows whether the communication arrangement is justified.

### BACKGROUND OF THE INVENTION

1. Field of the Invention

The present invention generally relates to the selection between different electronic procurement solution tools and more particularly to an improved process that automates the selection between different electronic procurement solution tools.

2. Description of the Related Art

The way in which a corporation deals with its suppliers of goods and services is conventionally a manual process. Some corporations have systems (manual and automated) that require the supplier to receive orders for goods and services according to a strict format (specific e-mail format, telephone format, facsimile format, etc.) and the suppliers are required to bill the purchasing corporation in a similar strict format.

Such standardization of ordering and billing increases the operating efficiency of the corporation's Purchasing and Accounts payable departments. However, as corporations become larger and larger, the number of employees in the Purchasing Department increases and the number of different suppliers also increases. Different suppliers may not be able to receive orders and produce bills according to the corporation's strict format and this problem increases as the size and diversity of the corporation's products increases. Therefore, as the corporation grows, a number of exceptions may be created to the strict ordering and billing formats required by the corporation to accommodate specific needs of individual suppliers. These exceptions decrease automation and increase the individual attention that is required by the purchasing and accounts payable departments, making them less efficient.

Therefore, there is a need for a tool which can readily handle exceptions to the strict ordering and payment format of a large corporation without departing from an automated system. Further, there is a need to automate the interface used by Purchasing and Accounts payable employees to ensure that exceptions to the strict format are not created. The invention described below addresses these and other needs and produces a novel solution to the foregoing problems.

### SUMMARY OF THE INVENTION

It is, therefore, an object of the present invention to provide a structure and method for selecting from a plurality of communication arrangements which inputs a first party's ability to communicate with a second party. The invention evaluates the communication arrangement based on the first party's ability to communicate. The invention repeats the evaluating process for a different communication arrangement if the first party's ability does not match a communication arrangement previously evaluated. The invention then selectively performs a cost-benefit analysis with respect to a communication arrangement matching the first party's ability and implements a communication arrangement when the first party's ability matches a communication arrangement. The cost-benefit analysis shows whether the communication arrangement is justified.

The communication arrangements are items such as purchase orders and billing communications between a purchasing corporation and a supplier. The first party is, for example, the supplier and the second party is the purchasing corporation. The evaluating procedure inputs the first party's ability into a decision tree. The decision tree orders communication arrangements that are evaluated by their cost effectiveness to the second party. The cost-benefit analysis compares the cost of establishing a matching communication arrangement to the cost of a next communication arrangement.

### BRIEF DESCRIPTION OF THE DRAWINGS

The foregoing and other objects, aspects and advantages will be better understood from the following detailed description of preferred embodiments of the invention with reference to the drawings, in which:

FIG. 1 is a flowchart according to one aspect of the invention;

FIG. 2 is a schematic diagram illustrating the relationship between suppliers, a purchasing agent, and different automated programs;

FIG. 3 is a schematic diagram of a decision tree;

FIGS. 4A-4D are cost/benefit analysis examples relating to the web calculator portion of the application; and

FIG. 5 is a schematic diagram of a hardware embodiment of the invention.

### DETAILED DESCRIPTION OF PREFERRED EMBODIMENTS OF THE INVENTION

As mentioned above, large corporations suffer significant inefficiencies when purchasing agents are required to make exceptions from a standard communication arrangement because of the special needs of a supplier. The invention described below accommodates the situation by providing the purchasing agents with a number of different standard communication arrangements and utilizes the input of the purchasing agents to make a calculated recommendation to the supplier. The use of multiple standard communication arrangements reduces the chance that a supplier will require a special arrangement, because most suppliers will be able to work under at least one of the communication arrangements. In addition, the invention provides a computerized decision tree based on input to allow all purchasing agents to consistently match the suppliers to the appropriate communication arrangements based on a series of Yes and No questions answered by the Purchasing Agent. Procurement personnel may have a limited understanding of the full complement of different communication arrangements that are available. Therefore, purchasing agents may not be prepared to discuss the differences in benefits of each communication arrangement and, without the invention, may make inconsistent decisions regarding which communication arrangements would be appropriate for a given type of supplier that are available and compatible with the corporation and the suppliers current business tools and communication devices.

Also, if the decision tree determines that the supplier is appropriate for a special communication arrangement that has exceptional costs (such as a Web-based communication arrangement), the invention automatically performs a cost-benefit analysis based on input from the Purchasing agent to determine whether such a specialized communication arrangement would be worthwhile for a given supplier. These and other features of the invention are shown in the drawings and discussed in greater detail below.

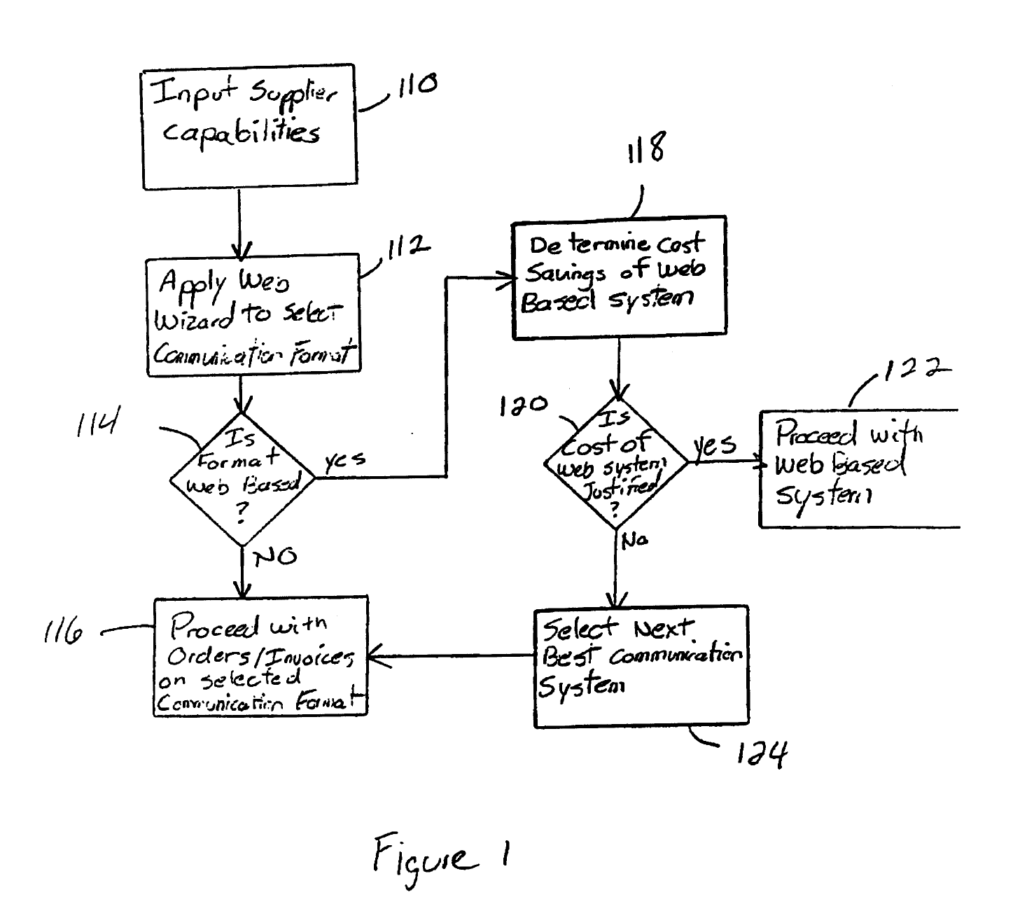

FIG. 1 is a flowchart illustrating a general overview of the invention. The process shown in FIG. 1 will be used for new suppliers or for existing suppliers that need to change their communication arrangement. For purposes of this invention, a communication arrangement is the mode and format by which a supplier receives purchase orders and sends invoices to a corporation. For example, one communication arrangement is a telephone ordering system where orders are placed over the telephone. Another communication arrangement is a facsimile communication arrangement. In this arrangement, orders are sent to a supplier's fax machine. In a similar manner, invoices can be returned to the corporation by fax. Another communication arrangement is an e-mail system, whereby orders are placed with the supplier and invoices are received from the supplier through an e-mail message system. Also, an online communication arrangement can be established whereby the supplier is provided access to the corporations network for the limited purpose of receiving orders and submitting invoices.

With the invention, each of the different communication arrangements can be automated or manual. For example, the automated telephone ordering system can trigger a voice synthesized telephone call to the supplier during which the supplier can acknowledge receipt of the purchase order by responding with a specialized code. Additionally, the facsimile, e-mail and on-line communication systems can similarly operate in an automated fashion. Therefore, when the corporations automated planning systems determine that additional items are required, these items can be ordered directly without consuming time or resources of individual purchasing agents. In addition, each different communication arrangement preferably has a fixed document format that all suppliers must comply with. The fixed document format insures that appropriate information is communicated and that it is communicated consistently during every communication. Therefore, the invention provides many types of telephone, many types of facsimile, many types of e-mail, and many types of on-line communication arrangements, where the only variation is the fixed document format.

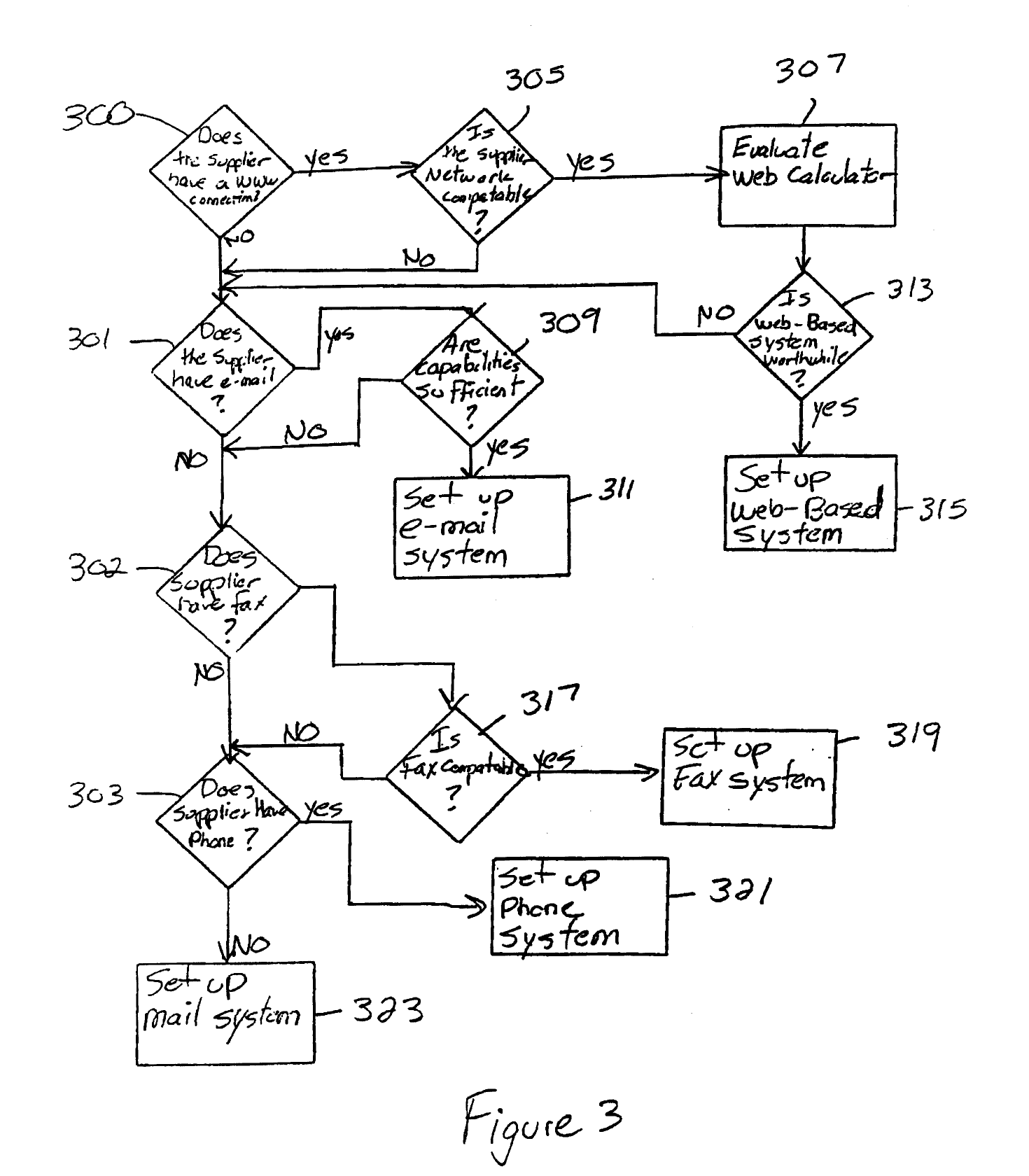

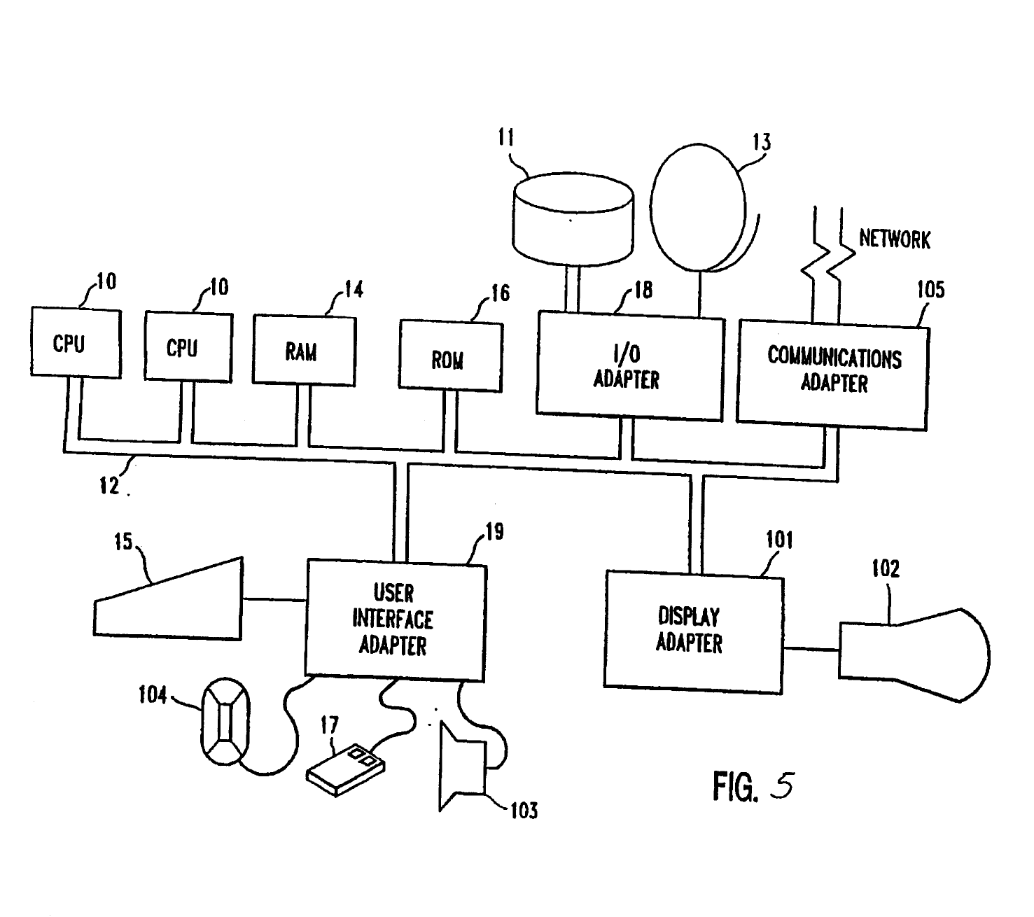

As shown in FIG. 1, item 110 represents the input of a supplier's capabilities. More specifically, the purchasing agent will interview the supplier to determine the transaction volume, types of purchase orders used, purchase order dollar values and other similar information. In item 112, the purchasing agent enters such information through a computer interface (e.g., FIG. 5) into the portion of the invention that provides the decision tree. The decision tree portion of the invention is referred to as a Web Wizard which automates the selection of the appropriate communication arrangement for the supplier in question. One example of a decision tree according to the invention is shown in FIG. 3 and is discussed in detail below.

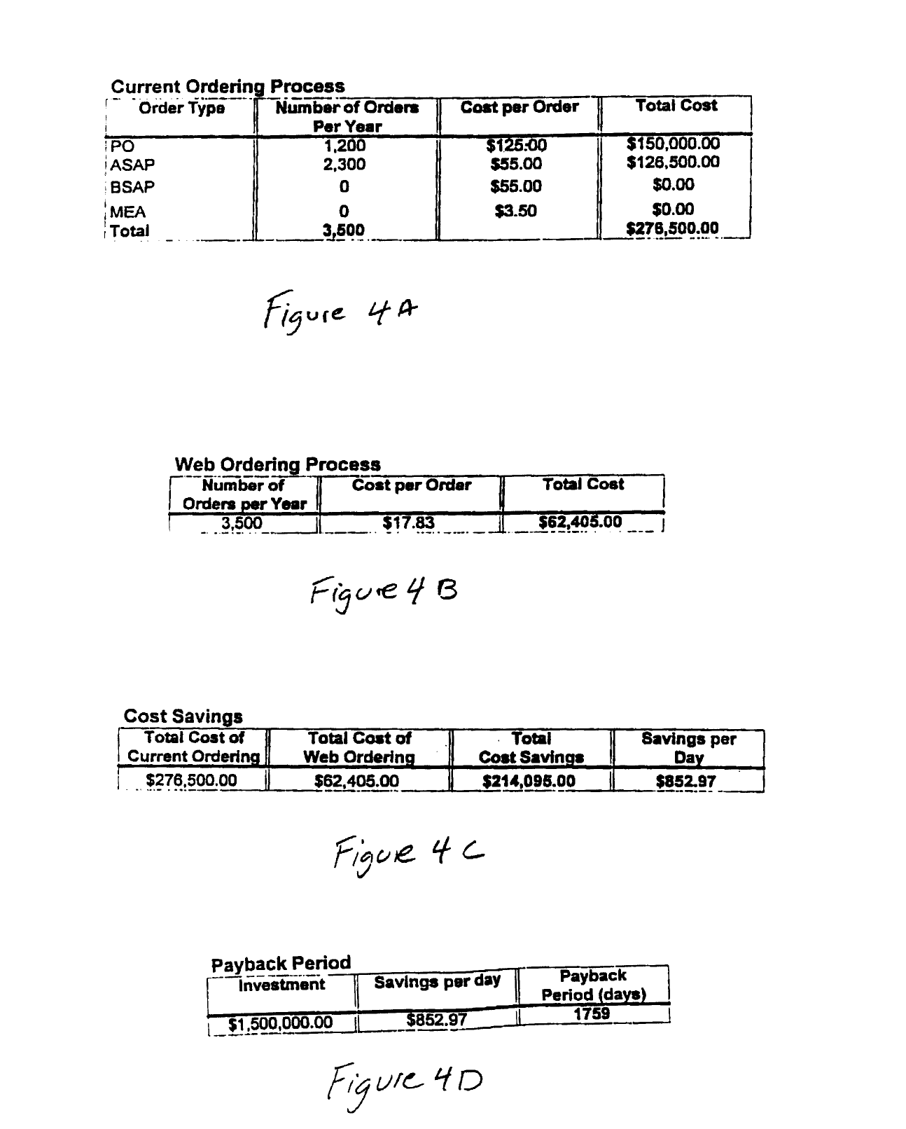

The decision tree shown in FIG. 3 will produce a recommended communication format/arrangement (e.g, fax, e-mail, etc.). In item 114, if the recommended format is Web-based, the invention determines the cost of processing orders through the Web-based system in item 118. FIGS. 4A-4D illustrate one example of determining the cost savings of a Web-based system and are discussed in greater detail below. Item 120 compares the cost of the Web-based system to the savings to determine whether the Web-based system is justified. If the Web-based system is justified, the invention proceeds with the Web-based system in item 122. If the Web-based system is not justified, the invention selects the next best communication system in item 124. Therefore, for example, if the Web-based system was not justified, the invention may revert to an e-mail communication system, or other non-network system, for the given customer, depending upon the results of the decision tree shown in FIG. 3. Then, the invention proceeds with orders and invoices on the selected communication arrangement/format, as shown in item 116.

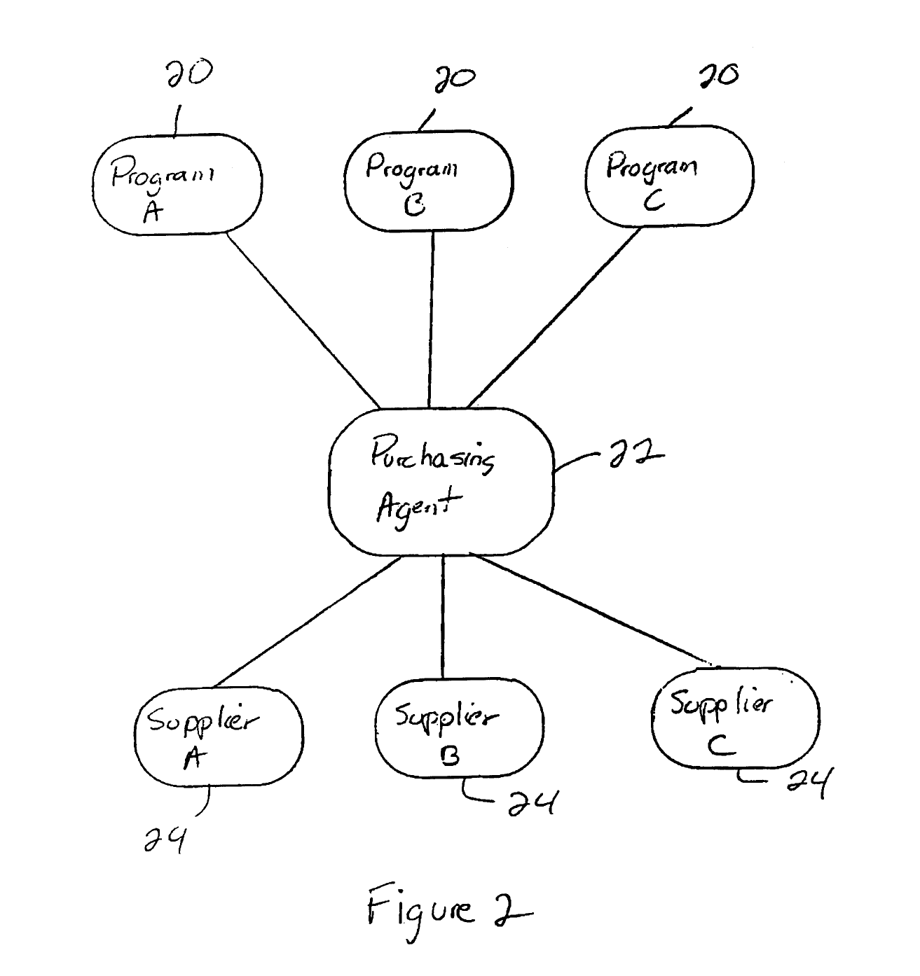

FIG. 2 is a schematic illustration which demonstrates how a purchasing agent 22 uses the Web Wizard portion of the invention to match appropriate communication arrangements 20 (programs A-C) with different suppliers 24 (suppliers A-C). As mentioned above, by providing a plurality of different communication arrangements 20 and an automated decision process (FIG. 3), the supplier 24 is provided with a communication arrangement/format that is appropriate and does not require inefficient individual attention by purchasing agents.

One very simplified embodiment of a portion of the Web Wizard of the invention is shown in decision tree format in FIG. 3. More specifically, in items 300-303, a series of initial questions are presented through the user interface (FIG. 5) to the purchasing agent 22. These questions are answered with information from the suppliers 24 to allow the purchasing agent 22 to properly select the appropriate communication arrangement 20. Question 300 inquiries as to whether the supplier has a world wide web or other similar wide area network connection. If the supplier does not have such a connection, the invention determines whether the supplier at least has e-mail in item 301. If the supplier does not have e-mail, the invention determines whether the supplier at least as the ability to communicate by facsimile in item 302. Finally, if there is no facsimile, the invention determines whether the supplier can communicate with the corporation by telephone in item 303.

If the supplier does have a World Wide Web (WWW) or similar wide area network connection, the invention determines whether the supplier is network compatible with the corporation in item 305. If not, the process reverts back to the inquiry regarding e-mail in item 301. If the supplier is network compatible, the Web calculator portion of the invention evaluates the cost of operating a Web-based communication arrangement in item 307. As discussed above, FIG. 4 illustrates one example of the calculation of a Web-based communication arrangement. In item 313, the invention determines whether the Web-based system is cost-effective. If it is, in item 315, the invention sets up the Web-based system. If not, processing returns to the e-mail determination in item 301.

If the supplier has e-mail capability, the invention determines whether the e-mail capabilities are sufficient for the requirements of the corporation in item 309. If the e-mail capabilities are sufficient, the invention sets up an e-mail communication arrangement in item 311. If not, processing proceeds to the facsimile inquiry in item 302.

If the supplier has the ability to receive and send facsimiles, the invention determines whether the facsimile abilities are sufficiently capable to satisfy the facsimile communication arrangements of the corporation in item 317. If the facsimile capabilities of the supplier are acceptable, the invention sets up the fax based communication arrangement in item 319. If not, the processing returns to determine whether the supplier has the ability to communicate by telephone in item 303. If the supplier has the ability communicate by telephone, the invention sets up the phone communication system in item 321. If not, the invention sets up a hard copy mail system in item 323.

Once again, the decision tree shown in FIG. 3 is only a simplified example of the processing performed by the invention and the invention is not limited to the specific decision tree shown in FIG. 3. To the contrary, the decision tree is a dynamic element of the invention that changes as different communication arrangements are established. Therefore, the decision tree will include questions and logical decisions to consistently steer all purchasing agents toward the same decisions regarding the appropriate communication arrangement. The questions and logical decisions will change from application to application depending upon the different requirements of the various communication arrangements that are available at a given time. The invention is applicable to all potential communication arrangements, such as the ones discussed above and others not discussed above. The invention is not limited to the specific communication arrangements discussed herein or the specific decision tree shown in FIG. 3, but instead is applicable to all systems where communication arrangements are selected through the use of a decision tree.

FIGS. 4A-4D illustrate one simplified example of the cost-benefit analysis performed to determine whether a purchaser should be provided with a communication arrangement that has substantial startup costs. There are many different communication arrangements that may have substantial startup costs. Each such communication arrangement should be evaluated to determine whether the costs associated with establishing the communication arrangement for a given supplier is worth the cost savings compared to the next best alternative communication arrangement.

One such communication arrangement that has substantial startup costs is the Web-based communication arrangement. More particularly, with the Web-based communication arrangement, the supplier actually gains very limited access to the corporation's internal network. Therefore, various applications must be provided to the supplier and the supplier must be trained with respect to the operation of the system. There can be additional costs to such an arrangement, such as security procedures, additional hardware purchases, etc. In the examples shown in FIG. 4D, the Web-based communication arrangement requires an investment of $1,500,000 per additional supplier.

In FIG. 4A, of the invention determines the cost of the next best alternative communication arrangement. For example, if the Web-based communication arrangement were not used, the next most likely communication arrangement would be an e-mail communication arrangement. FIG. 4A illustrates the costs associated with the next best communication arrangement (the e-mail arrangement). More specifically, as shown in FIG. 4A, for different order types, there will be a different number of orders placed per year. The different order types have different costs per order and the total cost can be calculated by simply multiplying the number of orders per year by the cost per order. FIG. 4B illustrates the costs per order of the Web-based communication arrangement for the same number of orders per year, to calculate the total cost of operating the Web-based system. In item 4C, the total cost of ordering over the Web-based system (FIG. 4B) is subtracted from the total cost of the next best alternative (e.g., FIG. 4A) to arrive at a total cost savings for the Web-based ordering system. This is also shown in a savings per day calculation. In item 4D, the savings per day is divided by the investment required for the Web-based system to determine the number of days required before the investment is paid back.

Therefore, the invention uses this information to determine whether the relationship with the supplier will extend beyond the payback period in determining whether the Web-based system is cost justified. As mentioned above, the Web-based system is merely exemplary and any communication arrangement which requires substantial investment is evaluated according to this method with the invention.

As shown above, the invention provides purchasing agents with a number of different standard communication arrangements. The use of multiple standard communication arrangements reduces the chance that a supplier will require a special arrangement, because most suppliers will be able to work under one of the communication arrangements. In addition, the invention provides a computerized decision tree based on input from the Procurement agent to allow all purchasing agents to consistently match the suppliers to the appropriate communication arrangements. If the decision tree determines that the supplier is appropriate for a special communication arrangement that has exceptional costs (such as a Web-based communication arrangement), the invention will perform a cost-benefit analysis based on input to determine whether such a specialized communication arrangement would be worthwhile for a given supplier.

Based on the input from the procurement agent a decision can be made to send orders to an internal organization for placement of orders through an operations center of procurement buyers, via e-mail or e-fax, to the supplier to avoid costly implementation of other previously mentioned methods.

It could also be decided by the input to send the orders to an integrated supplier who will act as an authorized Procurement Agent on behalf of the Purchasing Corporation for further cost avoidance. This tool and strategy are customizable to a corporation's strategic and tactical practices and business policies regarding the procurement of goods and services.

While the invention has been described in terms of preferred embodiments, those skilled in the art will recognize that the invention can be practiced with modification within the spirit and scope of the appended claims.

What is claimed is:

1. A method of selecting from a plurality of communication arrangements comprising:
inputting a first party's ability to communicate with a second party;
evaluating a communication arrangement based on said first party's ability to communicate;
repeating said evaluating for a different communication arrangement if said first party's ability does not match a communication arrangement previously evaluated; and
implementing a communication arrangement when said first party's ability matches a communication arrangement.

2. The method in claim 1, wherein said communication arrangements comprise purchase order and billing communications between a purchasing corporation and a supplier.

3. The method in claim 2, wherein said first party comprises said supplier and said second party comprises said purchasing corporation.

4. The method in claim 1, wherein said evaluating comprises inputting said first party's ability into a decision tree.

5. The method in claim 4, wherein said decision tree orders communication arrangements that are evaluated by their cost effectiveness to the second party.

6. The method in claim 1, further comprising before said implementing, performing a cost-benefit analysis with respect to a communication arrangement matching said first parties ability.

7. The method in claim 6, wherein said cost-benefit analysis compares the cost of establishing a matching communication arrangement to the cost of a next communication arrangement.

8. A method of selecting from a plurality of communication arrangements comprising:
inputting a first party's ability to communicate with a second party;
evaluating a communication arrangement based on said first party's ability to communicate;
repeating said evaluating for a different communication arrangement if said first parties ability does not match a communication arrangement previously evaluated;
performing a cost-benefit analysis with respect to a communication arrangement matching said first parties ability; and
implementing a communication arrangement when said first party's ability matches a communication arrangement and said cost-benefit shows said communication arrangement is justified.

9. The method in claim 8, wherein said communication arrangements comprises purchase order and billing communications between a purchasing corporation and a supplier.

10. The method in claim 9, wherein said first party comprises said supplier and said second party comprises said purchasing corporation.

11. The method in claim 8, wherein said evaluating comprises inputting said first party's ability into a decision tree.

12. The method in claim 11, wherein said decision tree orders communication arrangements that are evaluated by their cost effectiveness to the second party.

13. The method in claim 8, wherein said cost-benefit analysis compares the cost of establishing a matching communication arrangement to the cost of a next communication arrangement.

14. A program storage device readable by machine tangibly embodying a program of instructions executable by the machine to perform a method for selecting from a plurality of communication arrangements, said method comprising:
inputting a first party's ability to communicate with a second party;
evaluating a communication arrangement based on said first party's ability to communicate;
repeating said evaluating for a different communication arrangement if said first party's ability does not match a communication arrangement previously evaluated; and
implementing a communication arrangement when said first party's ability matches a communication arrangement.

15. The program storage device in claim 14, wherein said communication arrangements comprise purchase order and billing communications between a purchasing corporation and a supplier.

16. The program storage device in claim 15, wherein said first party comprises said supplier and said second party comprises said purchasing corporation.

17. The program storage device in claim 14, wherein said evaluating comprises inputting said first party's ability into a decision tree.

18. The program storage device in claim 17, wherein said decision tree orders communication arrangements that are evaluated by their cost effectiveness to the second party.

19. The program storage device in claim 14, further comprising before said implementing, performing a cost-benefit analysis with respect to a communication arrangement matching said first parties ability.

20. The program storage device in claim 19, wherein said cost-benefit analysis compares the cost of establishing a matching communication arrangement to the cost of a next communication arrangement.
